(19) United States
(12) Patent Application Publication
(10) Pub. No.: US 2003/0013521 A1
(43) Pub. Date: Jan. 16, 2003

(54) Method and apparatus for allowing uninterrupted gaming

(76) Inventors: Lawrence C. Cole, Linwood, NJ (US); Wayne W. Walkwitz, Atco, NJ (US); Paul C. McLaughlin, Brigantine, NJ (US)

Correspondence Address: Brown Raysman Millstein Felder & Steiner LLP, 1880 Century Park East Suite 711, Los Angeles, CA, 90067, US

(21) Appl. No.: 09/904,061

(22) Filed: Jul. 12, 2001

(51) Int. Cl. A63F 13/00

(52) U.S. Cl. 463/29; 463/20; 463/21; 463/22; 463/23; 463/24; 463/25

(57) ABSTRACT

The invention relates to a method of allowing a player to participate in an uninterrupted session of gaming while ensuring compliance with a regulation promulgated by a taxing authority, the regulations requiring that jackpots over a threshold amount won during gaming be reported. Player-related information adequate to comply with the regulation is stored prior to playing an uninterrupted session. When a reportable jackpot is won, jackpot-related information is stored such that it can be associated with the proper player-related information. The storage of jackpot-related information can be performed without any significant interruption in play. Thus, the invention avoids an extended “lock-up” period common in a conventional gaming system for recording of jackpot information whenever a significant jackpot is won. The player-related information, jackpot-related information, and information regarding the gaming establishment are associated and reported to the taxing authority after the uninterrupted session has ended.

### FIELD OF THE INVENTION

The invention relates to the field of gaming, specifically to gaming which provides monetary pay-outs.

### BACKGROUND OF THE INVENTION

Slot machines, video poker, and blackjack games are just a few of the many games of chance enjoyed by countless people. Gaming provides entertainment in its own right, but many players find gaming that involves a chance to win money especially exciting.

A problem with conventional gaming is that play must stop when jackpots of certain levels are won Stoppage in play is frequently required by regulations promulgated by taxing authorities, such as the United States Internal Revenue Service (IRS). In their most basic form, the regulations require that a gaming establishment collect information about jackpots greater than a threshold amount and report the jackpots to the taxing authority. Any jackpot meeting the requirement is known as a “reportable jackpot.” One example of a regulation, as promulgated by the IRS, requires that any person paying a jackpot in excess of $1,200 from a bingo game or slot machine play, or of $1,500 from a keno game, make an information return on Form W-2G. A Form W-2G must contain the following: (1) name, address, and employer identification number of the person making the payment; (2) name, address, and social security number of the winner; (3) general description of two types of identification (e.g., driver's license, social security card, or voter registration card) furnished to the payor for verification of the winner's name, address, and social security number; (4) date and amount of the payment; and (5) the type of wagering transaction. In addition, in the case of a bingo or keno game, Form W2-G must show any number, color, or other designation assigned to the game with respect to which the payment is made. In the case of a slot machine, Form W-2G must include the identification number of the machine. See 26 C.F.R. §7.6041-1 (2000).

In order to comply with the regulations, a gaming establishment must stop play any time a jackpot over the threshold is won in order to collect the required information for later reporting to the taxing authorities. As can be inferred from the amount of information which must be collected, substantial interruptions in play often result.

Such interruptions in play are undesirable. Once a reportable jackpot has been won, it may take three minutes or more for an attendant to respond, to record necessary information, and to pay the jackpot, time during which play is suspended. Such a delay is annoying to the player, and unprofitable for the establishment. When a player wins a reportable jackpot, the natural desire is to see the winnings immediately. Further, the player is naturally excited by such a win, increasing the desire to continue playing. It takes little imagination to see that an extended delay can be quite frustrating. The delay is equally undesirable from the establishment's point of view. Gaming machines are very expensive. The expense of the machine, together with other overhead, fixed costs, and labor costs must be recouped through players' use of the machine. Each moment that the machine sits idle is a lost opportunity to recoup those costs.

The problem is an extreme nuisance with regard to “high roller” gaming machines, some of which accept payments in denominations of $500 or more. These machines may require a stoppage in play for every win, even if the jackpot is relatively small. In gaming machine play, the stoppage may be in the form of a machine “lock-up,” whereby the jackpot is not credited to the player until an establishment agent comes to the machine to reset it. On a high roller machine, even a relatively modest 3 to 1 pay-out (e.g., $1500 for a $500 machine) may qualify as a reportable jackpot, causing the machine to lock up.

However, the problem is not limited to interruptions in play due to tax regulations, or to high roller machines. Indeed, even a machine which accepts small coins, such as nickels, may have a threshold amount, any jackpot over which will cause the machine to lock up. Such thresholds may be related to limitations on the number of coins the establishment wishes to pay out at one time, or the capacity of the machine. Similar thresholds may be encountered while participating in card games or roulette games as well.

### SUMMARY OF THE INVENTION

The present invention relates to a method of allowing a player to participate in uninterrupted gaming, even after a threshold jackpot, such as the threshold imposed by a tax regulation, has been won. The method provides a way of tracking all of the information required to comply with reporting regulations, while still allowing uninterrupted play.

The method requires that information related to a player be collected before the player is allowed to participate in an uninterrupted session. The player-related information must be adequate to comply with the regulations of the appropriate taxing authority. After collection, the player-related information is stored, preferably in a central computer linked to a gaming machine or electronically monitored card game. The player is then permitted to play for as long as may be desired, without interruption. When a jackpot in excess of a threshold amount is won, signals representing jackpot information are sent to a storage device, the signals preferably being in electronic form sent directly from the gaming machine or monitoring device to the central computer. Once the jackpot information is recorded, the winnings of the jackpot are credited to the player, and play continues.

Thus, the player can participate in uninterrupted gaming without play being interrupted to gather information to satisfy reporting regulations or for an establishment agent to reset a locked-up machine. If necessary, after the player is finished playing, a suitable statement including the required jackpot-related information and player-related information is printed and reported to the taxing authority. It is also desirable, and sometimes required, to provide the player with a similar statement.

### BRIEF DESCRIPTION OF THE DRAWINGS

For the purpose of illustrating the invention, there is shown in the drawings a form which is presently preferred; it being understood, however, that this invention is not limited to the precise arrangements and instrumentalities shown.

FIG. 1 is a flowchart representing a method for allowing uninterrupted gaming for a first time player according to the present invention.

FIG. 2 is a flowchart representing a method for allowing uninterrupted gaming for a returning player according to the present invention.

FIG. 3 is a schematic view of a preferred network for carrying out a method of allowing uninterrupted play according to the present invention.

FIG. 4 is a schematic view of a preferred gaming machine adapted for use in uninterrupted play according to the present invention.

### DETAILED DESCRIPTION OF THE DRAWINGS

In the drawings, wherein like numerals identify like elements, there are shown flowcharts representing a method, generally identified by the numerals 10 and 110, as well as a preferred network, generally identified by the numeral 200, both for providing players with uninterrupted gaming sessions.

It should be understood that the terms “uninterrupted session”, “uninterrupted play”, “uninterrupted mode” and the like may include some minor delays in play, as described herein. It should further be understood that the method is presently contemplated to be used to avoid interruptions caused by jackpots in excess of various threshold amounts. Because it is currently contemplated that the most commonly encountered threshold amounts may be those imposed by taxing authorities for reporting purposes, the invention is described in terms relating thereto.

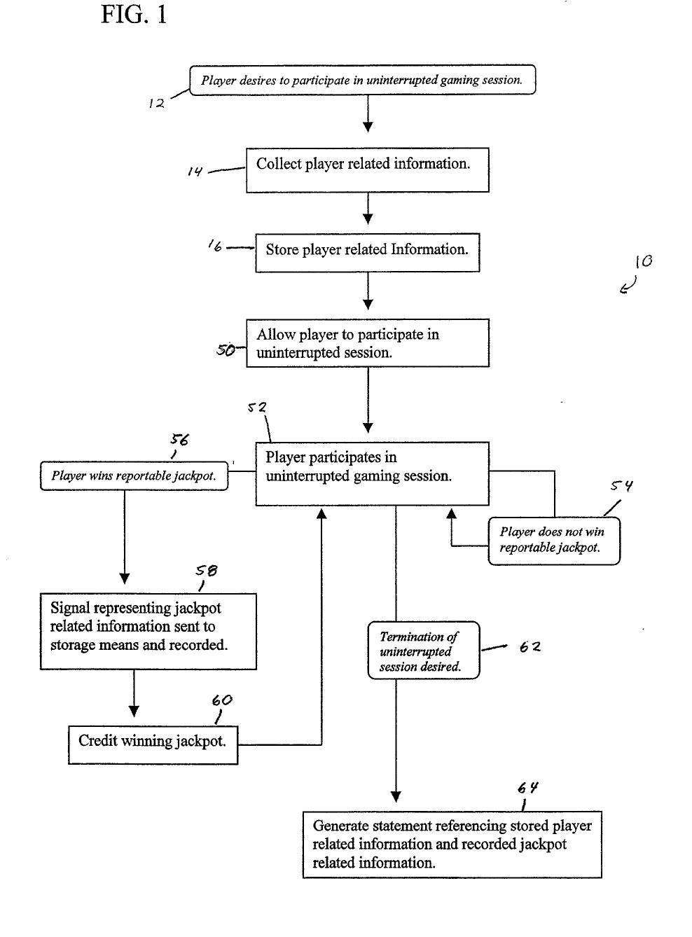

FIG. 1 shows a method of providing an uninterrupted gaming session for a first time player. The method, according to this form of the invention, begins with a first time player who desires to participate in an uninterrupted gaming session, as represented by box 12. The player communicates to the gaming establishment the desire to participate so that uninterrupted play can be allowed. Such communication may be express or implied, (e.g., appearing at a designated place), and may be at the player's initiative or be responsive to an invitation by the establishment. However, it is currently thought that the best way of communicating this desire is by simply telling an agent of the establishment. It is also contemplated that automated systems, such as a card reader or scanner and a computer, can perform the duties of the agent.

Before an uninterrupted session can begin the agent must collect, as shown in box 14, all of the player-related information which is needed to report certain jackpots pursuant to the regulations of each taxing authority which has jurisdiction over the establishment. The player-related information will vary depending on the jurisdiction where the gaming is to occur. By way of example, the player-related information may include the player's first, middle, and last names, the player's home address, the player's mailing address, the player's tax identification number, numbers from identification documents, such as a driver's license or passport, and the like. A gaming establishment in the United States, for instance, would require the name, address, social security number of the player, and the production of two acceptable forms of identification, pursuant to IRS regulations.

In most cases, inspection of the documents required in the information collection step will provide adequate proof of the prospective player's identity. In some situations, however, it may be advisable for the establishment to take additional measures to verify the identity of the player in order to insure that the information provided does, in fact, belong to that prospective player. Identity verification can be performed at any time before the player begins an uninterrupted session.

The player-related information must be stored by the establishment, such that it can be located at a later time, preferably with relative speed and ease. The storing step is represented by box 16. The preferred storage device is a centrally located computer, such as an IBM AS/400. The storage device can be any storage means, but is preferably an electronic device connected to a network.

Once all of the required player-related information is properly stored, the establishment may enable an uninterrupted session for the player. However, the establishment may, at its option, establish additional criteria which must be met before allowing uninterrupted play. For instance, the establishment may wish to limit uninterrupted play to its “very important people” or “high rollers.” In a preferred form of the invention, a prospective player is issued a player card once authorized for uninterrupted play. The player card may be a smart card which stores variable information or a conventional magnetic card identifying the player's account information, the account information being stored elsewhere. The use of similar cards for various different purposes is known in the art.

The establishment may allow uninterrupted play, represented by box 50, by either enabling a conventional gaming machine to enter an uninterrupted session or by providing the player with physical access to a game dedicated to uninterrupted play (e.g., an electronically monitored card game, a physically isolated gaming machine, or the like). In the preferred embodiment, a gaming machine must be enabled by an agent of the establishment. The enabling process is preferably performed at a gaming machine pre-programmed for uninterrupted play. The agent inserts an agent card into a card reader on the gaming machine. Insertion of the agent card causes the gaming machine to display a menu on a display screen. The agent may select uninterrupted play from the menu. The agent then removes the agent card, which starts a counter representing a set length of time in which the player may insert a player card. The player card, the issuance of which was referenced above, is then inserted into the gaming machine.

In the preferred embodiment, a pre-programmed computer protocol responds to the machine enabling process. The gaming machine sends at least one piece of player-related information, such as an account number stored on the player card, to the central computer. Further, the gaming machine sends information related to the enabling process, such as an agent identification number of the agent who is enabling the machine, to the central computer where it is recorded. Information related to the enabling process can later be recalled by the establishment as an audit trail. The central computer processes the player-related information and enabling information, and returns a signal indicative of whether the player is authorized for uninterrupted play. Provided the central computer confirms authorization, the gaming machine becomes enabled for uninterrupted play.

The preferred enabling process may be performed on more than one machine for a single player. If it is desired to concurrently play uninterrupted sessions on a plurality of machines, the player is issued multiple gaming cards, up to a limit set by the establishment. Thus, one gaming card per machine may be inserted into the respective card readers of multiple gaming machines, all of the player cards being encoded with the same player-related information.

Uninterrupted play, box 52, involves playing a game of chance on a machine which results in one of two classes of outcomes. Condition box 54 represents the outcome that the player has not won a reportable jackpot. Uninterrupted play proceeds in the same manner as conventional play so long as no reportable jackpot is won. That is to say, the amounts bet at the machine are paid or credited in, and any winnings are paid out, credited to a credit meter, or credited to an account. The player then continues to play in uninterrupted mode. It is worth noting that any known form of currency may be used with the invention. Such acceptable currency forms include bills, coins, credit or magnetic account cards, smart cards, coupons, etc. Accounting systems for gaming machines which allow cashless play are known to those skilled in the art.

Box 56 represents the condition that a reportable jackpot has been won. In the preferred embodiment of the invention, the gaming machine temporarily locks up in response to a winning jackpot greater than the threshold amount. In locked mode, a gaming machine is unresponsive to a player's commands. Also in response to the reportable jackpot, a signal is sent to a means for storing jackpot-related information, shown in box 58. In the preferred embodiment, the signals are digital signals sent from the gaming machine or an external controller board to the central computer. It is preferred that the signals be sent automatically, without any intervening act by the player or an establishment agent. Alternatively, the gaming machine or external controller board can be pre-programmed so that the player or an establishment agent must press a button in order to send the signals. The signals can also be processed and stored internally to the gaming machine. Jackpot-related information must include all of the information required to be reported to the taxing authority for the reportable jackpot. In the United States, the Internal Revenue Service requires such information as the date and amount of the jackpot, the type of wagering transaction, and game identification, including the identification of a slot machine or the number, color, or other designation assigned to a bingo or keno game. The name, address and employer identification number of the establishment may also be recorded as jackpot-related information, or be added to the final statement described below. It may be desirable to record additional information as well. Currently, it is contemplated that the following fields of information be recorded in response to a reportable slot machine jackpot: asset, zone, location, date, time, denomination, jackpot amount, payment amounts by method of payment, coins played, play line, and winning combination. The jackpot-related information is recorded in a manner so that it corresponds with at least one unique field of player-related information, allowing the establishment to subsequently associate jackpot-related information with all of the appropriate player-related information, which was stored in the step associated with box 16.

It should be noted that, in some embodiments, the gaming machine does not enter a locked mode in response to a reportable jackpot win. In those embodiments, the signals representing jackpot-related information are sent to the means for storing jackpot-related information, and play continues as described herein. Play is interrupted only if a stop signal is returned to the external controller board or gaming machine in response to the signals representing jackpot-related information. Stop signals may be returned, for example, in the event of a termination command or a write error at the storage means.

Concurrently with the signal transmission or recording of the jackpot-related information, or after recording is complete, the gaming machine credits the winning jackpot, represented by box 60. It is preferred that crediting be performed after the jackpot-related information has been recorded and a confirmation signal automatically returned to the gaming machine by the central computer. The confirmation signal also triggers the gaming machine to unlock if it has entered a locked mode. In the preferred embodiment, the recording occurs at the central computer, such as the AS/400 described above, and the confirmation signal is returned within a fraction of a second. Thus, the crediting of the jackpot and unlocking of the gaming machine (if locked) occur almost immediately after the reportable jackpot is won. In variations of the method, the crediting of the jackpot to the gaming machine can be performed automatically or manually. Automatic crediting applies the jackpot amount to the player's credits without input from the player. Manual crediting, also referred to as player interactive mode, requires that the player push a button to credit or pay out the jackpot. The gaming machine may be pre-programmed to pay out in a number of ways including, by way of example: (1) a hopper pay-out, usually the physical discharge of coins or tokens from the hopper to the machine tray where the player can access the coins or tokens; (2) crediting the jackpot to a player account which has a balance stored on a smart card, or stored electronically at the central computer or at an outside financial institution; or (3) a credit pay-out, which involves credits being incremented within the machine, which the player can cash out at will, for example, by hitting a cash-out button. Once the crediting of the jackpot is complete, the game is ready to play again.

A user can perform up to 14 or more plays per minute at a typical slot machine. As noted above, it may take about three minutes or more for an attendant to respond, to record necessary information and to pay a reportable jackpot in a conventional gaming system, time in which play is suspended. It has been found that using the method of the invention according to the preferred form described herein, the recording of jackpot-related information and crediting of jackpots to the gaming machine can be accomplished at a rate which potentially allows the player more than 40 extra plays at a slot machine after a reportable jackpot. This is an especially great advantage in high roller machines, on which frequent jackpots may be reportable. In light of the method described herein, the advantages of the method should be obvious to one familiar with the operation of a gaming establishment. An increase in the number of potential plays of a gaming machine both maximizes profit margin and increases player satisfaction. Uninterrupted play can continue for as long as the player and the establishment wish.

If the establishment so desires, limits can be set for the value of jackpots won during uninterrupted play. It may be desirable to stop uninterrupted play when an unusually large jackpot is won. If desired by the establishment, a very large jackpot will trigger the gaming machine to enter a locked mode, similar to that of a conventional gaming machine when a substantial jackpot is won. Entry into locked mode allows an establishment agent to inspect the gaming machine and ensure that the proper jackpot-related information has been recorded before crediting the jackpot and resetting the machine. The pause in gaming further allows the establishment to verify that no tampering with the machine has occurred.

When it is desired to end the uninterrupted play session, the condition represented by box 62, the player or establishment must communicate that desire to the other. If the player wishes to terminate the session, a button may be pushed to summon an establishment agent. In the preferred embodiment, removal of the player card from the card reader will cause the machine to terminate the uninterrupted session and alert the establishment, via communication with the central computer, that the session has ended.

The establishment then generates a statement which shows all the jackpot-related information recorded during the uninterrupted session, represented by box 64. The statement also includes player-related information as well as other information required by the regulation of the jurisdiction's taxing authority, such as the name, address, and employer identification number of the establishment. In forms of the invention where the jackpot-related information and player-related information have been stored in separate storage devices, the establishment will need to combine the player information with the corresponding jackpot-related information prior to generating the statement. In the preferred form, the central computer correlates the player-related information and jackpot-related information in order to generate the statement automatically. The central computer may direct the printing of the statement at any convenient location. It is generally desirable to provide a copy of the statement to the player. Ultimately, a copy of the statement or another statement generated at a later time, will be provided to the taxing authorities. In the United States, the statement comprises IRS Form W-2G.

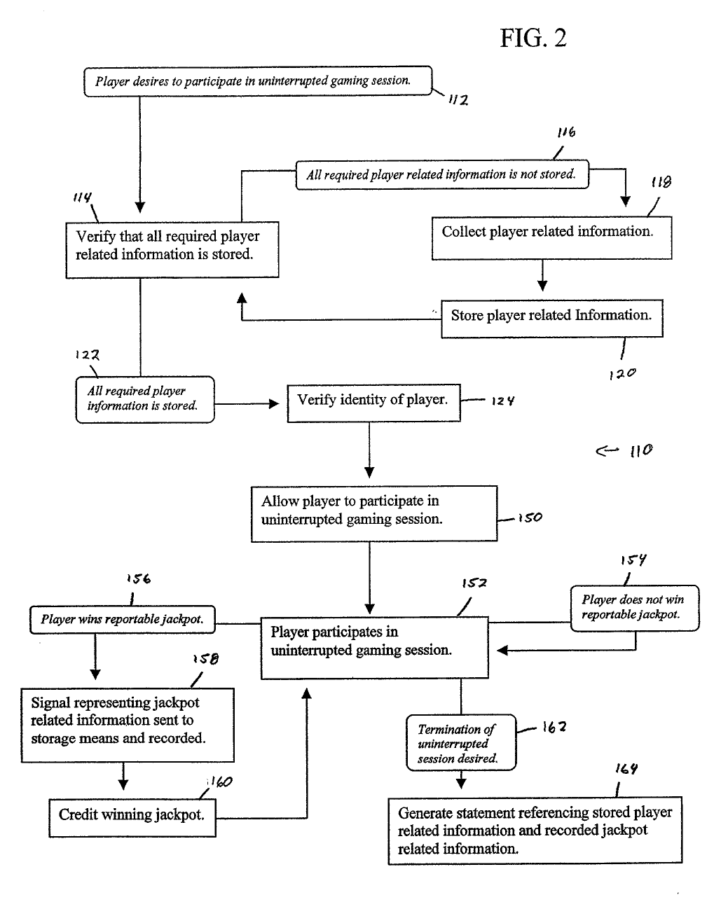

FIG. 2 is a flowchart showing the present invention in the case of a returning player desiring to participate in an uninterrupted gaming session. In this case, the returning player's player-related information will already have been stored by the establishment. When the returning player wishes to begin an uninterrupted session, box 112, the establishment verifies that the required player-related information is still stored and remains current, as shown in box 114. Condition box 116 represents the possibility that all the required player-related information is not stored or that some of the required player-related information has changed. In this case, the establishment must again collect, box 118, and store, box 120, the player-related information as described above with respect to FIG. 1.

If all required player-related information is stored, the condition represented by box 122, the establishment verifies, box 124, the identity of the player to ensure the player-related information belongs to the player. Of course, the identity of the player can also be verified before or concurrently with the verification of the proper storage of player-related information (box 114).

Once the establishment has verified the identity of the player and has verified that the required player-related information is stored, uninterrupted play can be allowed. In the same manner as described above with regard to FIG. 1, the establishment allows the player to participate in an uninterrupted session, box 150, by either enabling a gaming machine by putting it in uninterrupted mode or providing the player with physical access to a game of chance dedicated to uninterrupted play.

Play, represented by box 152, occurs in the same manner as described with regard to FIG. 1. Play which does not result in a reportable jackpot, the condition represented by box 154, proceeds in the same manner as conventional play. Play resulting in a reportable jackpot is represented by box 156. Once a reportable jackpot is won, signals representing jackpot-related information are sent to a storage means and recorded, shown in box 158. In the preferred form of the invention, the machine also enters a temporary lock mode in response to the reportable jackpot. Signals automatically returned from a central computer unlock the machine upon recording the jackpot-related information. The reportable jackpot is credited, shown in box 160, to the machine in any of the forms described above with regard to box 60. Play continues until termination of the session is desired, the condition shown in box 162. Once termination of the session is desired, as in box 164, the statement or statements are generated as described above with regard to box 64.

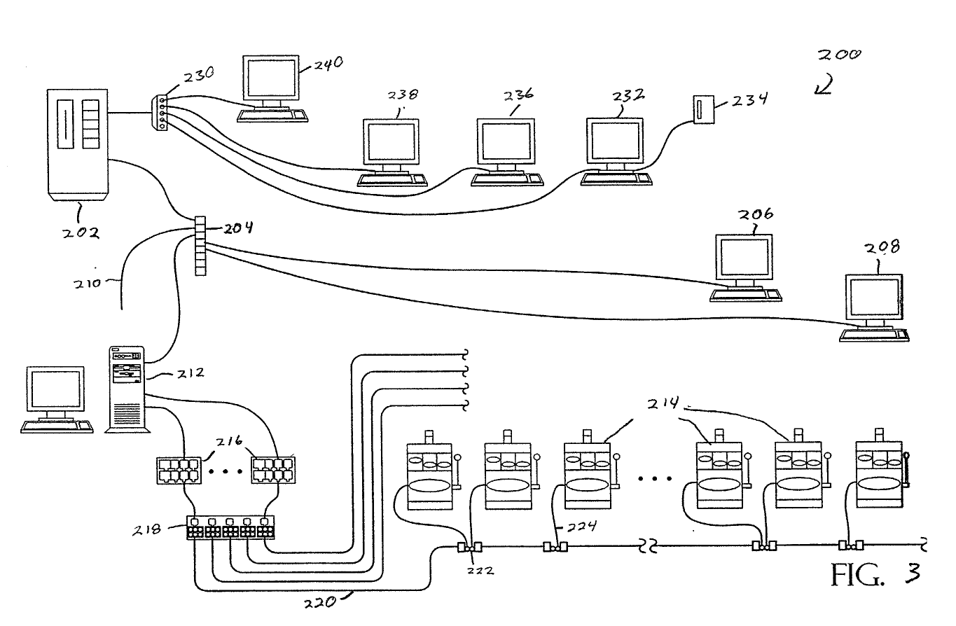

FIG. 3 is a schematic diagram of a preferred network 200 capable of performing the method shown in FIGS. 1 and 2. The network is preferably configured as an ethernet or IEEE 802.3 compliant system in a star configuration. Alternatively, the system may be a token ring network, preferably compliant with the IEEE 802.5 standard. A central control unit, preferably central computer 202, is connected to a system hub 204. As noted above, the central computer can be an IBM AS/400 mainframe. The system hub 204 comprises a plurality of jacks for RJ-45 connectors and circuitry that links the network cables, preferably 10Base-T or 100Base-T cables, together.

Connected to the hub 204 is an operations office terminal 206, and a maintenance office terminal 208. Additional computers or terminals can also be connected to hub 204 via one or more cables 210. The terminals (not shown) connected to cable 210 may serve numerous functions and include a promotional terminal for printing coupons on the gaming floor or a host access server.

A concentrator 212 is also attached to hub 204. Concentrator 212 is a computer capable of communicating with hundreds of machines, well known to those skilled in the art. Concentrator 212 includes a terminal for an operator to monitor the system and provide inputs thereto. Connected to the concentrator 212 are gaming machines 214. The connection between gaming machines 214 and the concentrator 212 may be by serial links, such as RS-232 or RS-485, depending on the distance between machines and the number of machines connected. Optical isolators 216 can be integrated in the system between the gaming machines 214 and the concentrator 212. Optical isolators 216 can serve as converters from one signal type to another, and protect the gaming machines 214 and concentrator 212 from power surge damage and minimize noise and other interference in the system.

Line panels 218 are preferably integrated in the network. A series of home runs 220 connect a line panel 218 with the gaming machines 214. Each home run 220 can support a plurality of gaming machines 214, each machine being connected to a home run 220 via a pass through connector 222 and a data line 224. Also connected to the line panel may be various other desirable devices such as a bill counter, a coin scale, a garage gate, or a door access device (not shown).

A second hub 230 is connected to the central computer 202. Various computer terminals are connected to the second hub 230. Preferably, at least one of the computers attached to the second hub 230 is club booth computer 232. The club booth computer 232 is equipped with a player card encoder 234 which is capable of providing or encoding a player card, required in the preferred method described above to enable a gaming machine to begin an uninterrupted session. Also connected to the second hub 204 may be a casino host 236, change booth computers 238, and an accounting office computer 240.

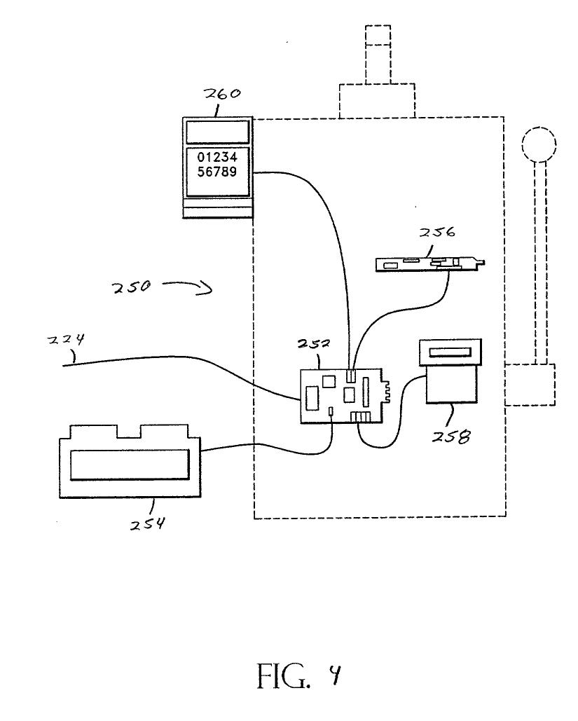

FIG. 4 is a schematic view of a preferred gaming machine 250 adapted to be connected to the network 200. The data line 224 running into the machine is connected with a game controller card 252. The controller card 252 is in communication with a hopper scale 254 and a microprocessor 256 for controlling the operation of the gaming machine 250. Also connected to the controller card is a validator interface 258 for accepting coupons or other forms of non-cash payment. A keypad unit 260, equipped with a display and a card reader, is provided for reading the agent card and player card and for allowing inputs for preprogrammed menu selections as described above with regard to the preferred enabling step.

The preferred network and gaming machine arrangements shown in FIGS. 3 and 4 are only two examples of many hardware arrangements contemplated to be within the scope of the present invention. As noted above, one alternative arrangement includes a gaming machine controller card external to the gaming machine (not shown). Such an arrangement is ideal for use in “bar top” machines, for example, where space within the machine is limited. In such an arrangement, the concentrator may be connected to the controller board, which is in communication with a gaming machine. In another alternative arrangement, the network may be incorporated entirely within a single gaming machine, which houses the means for inputting, recording, and storing player-related and jackpot-related information, and for printing the required statements. In still another alternative arrangement, the microprocessor 256 and controller card 252 may be combined into a single board.

It should be clear from the foregoing that a method as described herein, preferably used with a network like network 200, provides a means for allowing participation in an uninterrupted gaming session. The advantages of the uninterrupted session should be equally clear. Use of the preferred method and network will free players from undesirable interruptions in play, while at the same time provide the gaming establishment with higher profitability for each enabled machine.

The present invention may be embodied in other specific forms without departing from the spirit or essential attributes thereof and, accordingly, reference should be made to the appended claims, rather than to the foregoing specification, as indicating the scope of the invention.

What is claimed is:

1. A method of allowing a player to participate in an uninterrupted gaming session when a jackpot over a threshold amount is won, the method comprising the steps of:
collecting player-related information;
storing the player-related information;
allowing the player to participate in a gaming session substantially uninterrupted;
recording jackpot-related information whenever a jackpot greater than a threshold amount is won;
crediting winnings to the player; and
generating a statement referencing the recorded jackpot-related information and stored player-related information after the player is done playing.

2. The method of claim 1, wherein the allowing step comprises the step of enabling a pre-programmed gaming machine to play an uninterrupted session, even if a reportable jackpot is won.

3. The method of claim 2 wherein the enabling step comprises the steps of:
inserting an agent card;
selecting uninterrupted play from a menu screen on a display; and
inserting a player card.

4. The method of claim 1 wherein the allowing step comprises the step of providing the player with physical access to a game of chance dedicated to uninterrupted play.

5. The method of claim 1, wherein the collecting step further comprises the step of:
examining documents which qualify as proof of the player's identity.

6. The method of claim 1, wherein the collecting step further comprises the step of:
obtaining tax related information about the player.

7. The method of claim 6, wherein the obtaining step further comprises the step of:
looking at a document selected from the group consisting of the player's driver's license, the player's social security card, and the player's voter registration card.

8. The method of claim 6 wherein the tax related information comprises the name, address, and tax identification number of the player.

9. The method of claim 1, further comprising the step of reporting jackpot-related information and player-related information to a taxing authority.

10. The method of claim 1, further comprising the step of providing the player with a statement referencing jackpot-related information after the player is done playing.

11. An interactive network linking at least one gaming machine and a central control unit for allowing uninterrupted play, the network comprising:
a central storage unit in electronic communication with the central control unit, the central storage unit having stored player-related information adequate for compliance with reporting requirements of a taxing authority;
at least one gaming machine in communication with the central control unit, the at least one gaming machine being arranged to lock up whenever a jackpot greater than a threshold amount is won, the at least one gaming machine sending signals representing jackpot-related information to the central control unit, and the jackpot-related information being adequate for compliance with reporting requirements of a taxing authority;
the central control unit automatically returning signals to the at least one gaming machine when jackpot-related information is recorded, the returned signals causing the at least one gaming machine to unlock; and
a reporting unit in communication with the central control unit, the reporting unit capable of producing statements referencing player-related information and jackpot-related information.

12. The network of claim 11 wherein the central control unit is a computer.

13. The network of claim 11 wherein the player-related information includes a name, an address, and a tax identification number of a player.

14. The network of claim 11 wherein the reporting unit comprises a printer for printing jackpot-related and player-related information in a form required by a taxing authority.

15. The network of claim 11 wherein the at least one gaming machine includes a microprocessor programmed with a protocol for uninterrupted play.

16. The network of claim 15 further comprising a networking computer connected to a plurality of gaming machines and the central control unit, the networking computer facilitating electronic communication between the plurality of gaming machines and the central control unit.

17. The network of claim 15 further comprising a player card encoder, wherein each of the at least one gaming machines is in electronic communication with a card reader capable of reading information encoded on a player card.

18. The network of claim 17 wherein the at least one gaming machine is in communication with a keypad.

19. The network of claim 18 wherein the protocol for uninterrupted play is capable of being activated by an enabling event.

20. The network of claim 19 wherein the enabling event includes insertion of an agent card into the card reader, selection of uninterrupted play using the keypad, and insertion of a player card into the card reader.

21. The network of claim 20 wherein the protocol for uninterrupted play is deactivated by removal of the player card from the card reader.

22. The network of claim 15 wherein physical access is limited to the at least one gaming machine.

23. A computer program product comprising a computer useable medium having a protocol stored thereon, wherein said protocol comprises machine readable code to enable a computer network to allow for an uninterrupted play session on a gaming machine, even when a reportable jackpot is won, wherein the machine readable code comprises:
code to enable a central storage computer to store player-related information;
code to enable a gaming machine to enter an uninterrupted play session in response to a user input;
code to enable a gaming machine to send signals representing jackpot-related information to the central storage computer when a reportable jackpot is won;
code to enable the central storage computer to receive and record jackpot-related information;
code to enable a gaming machine to communicate to the central storage computer that an uninterrupted session has ended; and
code to allow the central storage computer to generate a statement including player-related information and jackpot-related information after an uninterrupted session has ended.

24. A method of allowing a player to participate in an uninterrupted session on a gaming machine in electronic communication with a central computer, even when a reportable jackpot is won, the method comprising the steps of:
collecting player-related information;
storing the player-related information in an electronic medium such that it can be accessed by the central computer;
allowing the player to play substantially uninterrupted on the gaming machine;
sending signals representing jackpot-related information from the gaming machine to an electronic storage device when a reportable jackpot is won;
recording the jackpot-related information in an electronic medium such that it can be accessed by the central computer;
crediting winnings to the gaming machine;
accessing the player-related information and jackpot-related information when the player is done playing; and
generating a statement referencing jackpot-related information and player-related information, the statement being in a form complying with tax regulations.

25. The method of allowing a player to participate in an uninterrupted session of claim 24 further comprising the step of returning signals from the central computer to the gaming machine after the jackpot-related information has been recorded, the returned signals causing the gaming machine to unlock.

26. The method of allowing a player to participate in an uninterrupted session of claim 24 wherein the allowing step comprises the steps of
providing the player with a player card encoded with at least one piece of player-related information;
inserting an agent card into a card reader in communication with the gaming machine;
entering enabling information into a keypad in communication with the gaming machine;
removing the agent card from the card reader;
introducing the player card into the card reader;
sending enabling information from the gaming machine to the central computer;
receiving a return signal from the central computer confirming authorization to participate in uninterrupted play; and
beginning an uninterrupted session on the gaming machine.

27. The method of allowing a player to participate in an uninterrupted session of claim 24 wherein the allowing step comprises the step of providing physical access to a gaming machine dedicated to uninterrupted play.

28. The method of allowing a player to participate in an uninterrupted session of claim 24 wherein the statement comprises IRS Form W2-G.

29. A method of allowing uninterrupted gaming on a gaming machine, the method comprising:
collecting player-related information adequate to satisfy the reporting requirements of a taxing authority;
storing the player-related information;
allowing the player to participate in an uninterrupted gaming session;
locking-up the gaming machine when a jackpot greater than a threshold amount determined by the taxing authority is won;
sending electronic signals representing jackpot-related information from the gaming machine to a central computer when a jackpot greater than the threshold amount is won, the jackpot-related information being adequate to satisfy the reporting requirements of the taxing authority;
recording the jackpot-related information when electronic signals representing the jackpot-related information are sent from the gaming machine to the central computer;
returning signals from the central computer to the gaming machine when jackpot-related information has been recorded;
automatically unlocking the gaming machine in response to the returned signals; and
generating a statement referencing the recorded jackpot-related information and stored player-related information after the player is done participating.

30. The method of claim 29, wherein the collecting step further comprises the step of:
looking at a document selected from the group consisting of the player's driver's license, the player's social security card, and the player's voter registration card.

31. The method of claim 29, further comprising the step of reporting jackpot-related information and player-related information to a taxing authority.

32. The method of claim 29, further comprising the step of providing the player with a statement referencing jackpot-related information after the player is done participating.

33. The method of claim 29, wherein the allowing step comprises the step of enabling a pre-programed gaming machine to execute a protocol putting the gaming machine in to uninterrupted mode.

34. The method of claim 33 wherein the enabling step comprises the steps of:
inserting an agent card;
selecting uninterrupted play from a menu screen on a display; and
inserting a player card.

35. The method of claim 29 wherein the allowing step comprises the step of providing the player with physical access to a game of chance dedicated to uninterrupted play.

36. An interactive network linking at least one gaming machine and a central control unit for allowing uninterrupted play, the network comprising:
a central storage unit in electronic communication with the central control unit, the central storage unit having stored player-related information adequate for compliance with reporting requirements of a taxing authority;
at least one gaming machine in communication with the central control unit, the at least one gaming machine being arranged to interrupt play only whenever a stop signal is received from the central control unit or an error occurs, the at least one gaming machine sending signals representing jackpot-related information to the central control unit whenever a reportable jackpot is won, and the jackpot-related information being adequate for compliance with reporting requirements of a taxing authority;
the central control unit automatically returning stop signals to the at least one gaming machine if a write error occurs when jackpot-related information is recorded, the returned stop signals causing the at least one gaming machine to interrupt play; and
a reporting unit in communication with the central control unit, the reporting unit capable of producing statements referencing player-related information and jackpot-related information.

37. The network of claim 36 wherein the central control unit is a computer.

38. The network of claim 36 wherein the player-related information includes a name, an address, and a tax identification number of a player.

39. The network of claim 36 wherein the reporting unit comprises a printer for printing jackpot-related and player-related information in a form required by a taxing authority.

40. The network of claim 36 wherein the at least one gaming machine includes a microprocessor programmed with a protocol for uninterrupted play.

41. The network of claim 40 further comprising a networking computer connected to a plurality of gaming machines and the central control unit, the networking computer facilitating electronic communication between the plurality of gaming machines and the central control unit.

42. The network of claim 40 further comprising a player card encoder, wherein each of the at least one gaming machines is in electronic communication with a card reader capable of reading information encoded on a player card.

43. The network of claim 42 wherein the at least one gaming machine is in communication with a keypad.

44. The network of claim 43 wherein the protocol for uninterrupted play is capable of being activated by an enabling event.

45. The network of claim 44 wherein the enabling event includes insertion of an agent card into the card reader, selection of uninterrupted play using the keypad, and insertion of a player card into the card reader.

46. The network of claim 45 wherein the protocol for uninterrupted play is deactivated by removal of the player card from the card reader.

47. The network of claim 40 wherein physical access is limited to the at least one gaming machine.

48. A controller card for a gaming machine comprising a board having
logic for allowing an establishment agent to put the gaming machine into uninterrupted mode;
logic for sending signals indicative of jackpot-related information to a means for storing jackpot-related information whenever a reportable jackpot is won; and
logic for interrupting play on the gaming machine in response to a stop command.

49. The controller card of claim 48 wherein the board is a component of the gaming machine.

50. The controller card of claim 48 wherein the board is external to the gaming machine.
